(19) United States
(12) Patent Application Publication
(10) Pub. No.: US 2013/0093782 A1
(43) Pub. Date: Apr. 18, 2013

(54) Color Selection and Chart Styles

(71) Applicants: Robin Wakefield, Seattle, WA (US); Christopher Doan, Redmond, WA (US); Christopher Becker, Redmond, WA (US)

(72) Inventors: Robin Wakefield, Seattle, WA (US); Christopher Doan, Redmond, WA (US); Christopher Becker, Redmond, WA (US)

(73) Assignee: Microsoft Corporation, Redmond, WA (US)

(21) Appl. No.: 13/272,385

(22) Filed: Oct. 13, 2011

(51) Int. Cl. G09G 5/02

(52) U.S. Cl. 345/589

(57) ABSTRACT

Color selection may be provided. First, a selection of a target object may be received and a color selection mode may be entered. Then a color preview may be provided in response to entering the color selection mode. Next, a color selection may be received in response to providing the color preview. A color of a property of the selected target object may then be set to the received color selection.

### BACKGROUND

A chart is a graphical representation of data where data is represented by symbols, such as bars in a bar chart, lines in a line chart, or slices in a pie chart. A chart can represent tabular numeric data, functions, or some kinds of qualitative structures. Charts are often used to ease understanding of large quantities of data and the relationships between parts of the data. Charts can usually be read more quickly than the raw data that they are produced from.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

Color selection may be provided. First, a selection of a target object may be received and a color selection mode may be entered. Then a color preview may be provided in response to entering the color selection mode. Next, a color selection may be received in response to providing the color preview. A color of a property of the selected target object may then be set to the received color selection.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 is a flow chart of a method for providing color selection;

FIG. 3 is a diagram illustrating a computing device screen;

FIG. 4A is a diagram illustrating a format object dialog box;

FIG. 4B is a diagram illustrating a drop down menu;

FIG. 5 is a diagram illustrating a user manipulatable pointer;

FIG. 6 is a diagram illustrating an icon;

FIG. 7 is a block diagram of a system including a computing device;

FIG. 8 is a flow chart of a method for providing chart styles;

FIG. 9 is a diagram illustrating a color gallery; and

FIG. 10 is a diagram illustrating a styles gallery.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Consistent with embodiments of the present invention, a color selection tool may be provided that may allow a user to choose a color by clicking on a pixel on a screen, and then apply the chosen color to an object property. In other words the user may choose a color by sampling the value (e.g. RGB, CMYK, Pantone, etc.) of a pixel on the screen within a workspace. In addition, the user may interact with application controls (e.g. scrollbars, zoom level, etc.) while using the color selection tool. For example, the user may want to make a slide deck presentation look professional by creating a cohesive color scheme based on the images in a presentation. Using the color selection tool, the user may sample various colors from images on the screen (e.g. within a document) and then apply the sampled colors to, for example, a slide background, text, and objects on the screen. For more accurate color selection, the user may use a zoom control to zoom into images while using the color selection tool. As a result, the user may produce a finished product (e.g. a slide deck presentation) whose contents reflect a consistent color palette. Embodiments of the invention also work for document theme colors where the color picked is mapped to something that will match the document when the selected object is moved into another document or when the user chooses to make their document look different. Any color type (e.g. RGB, CMYK, Pantone, etc.) may be used with embodiments of the invention.

Consistent with embodiments of the present invention, the user may perform “in-dialog” color sampling. For example, the user may be using a Format Object Dialog to add and tweak effects on an object. The user may be working, for example, with a blue shape and would like to give it a glow with the same shade of blue. From within the Format Object Dialog, the user may accesses the color selection tool, samples the desired color from the shape, and sets the glow color.

In another example, the user may sample from outside the current work space. For example, the user may be creating a presentation and may want to make the background of a slide match the color of a company's logo. To accomplish this, the user may load the company's webpage on a browser, uses the color selection tool to sample the desired color from the webpage, and set the background color.

In yet another example, a user may sample colors from, for example, a different slide. The user may want the outline of an image to be the same color as a shape the user has on a different slide. While using the color selection tool, the user may scroll to another slide, samples the desired color, and apply the sampled color to the original image.

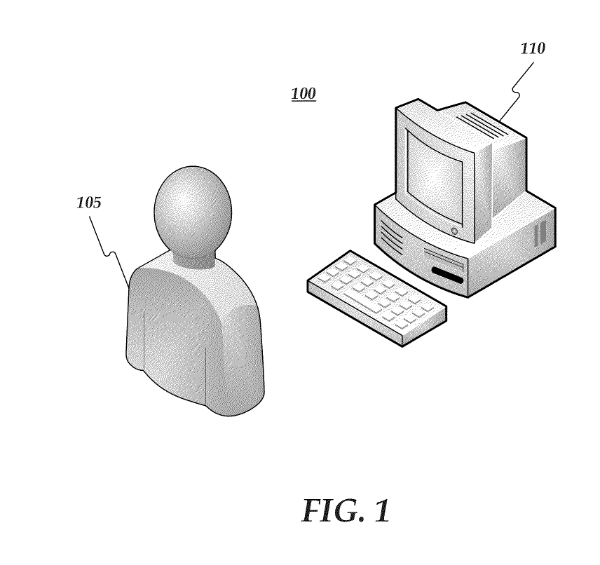

FIG. 1 is a block diagram of an operating environment 100. Operating environment 100 may include a user 105 and a computing device 110. Interacting with computing device 110, user 105 may create, for example, a slide deck presentation. When creating the slide deck presentation, consistent with embodiments of the invention, user 105 may use a color selection tool that may sample (e.g. surface) RGB values on computing device 110's screen on hover to show exact color values that can be sampled. With conventional systems, users used guesswork and entering RGB values manually picking colors by eye and were thus not able to set the color of a shape property to match something else on a screen.

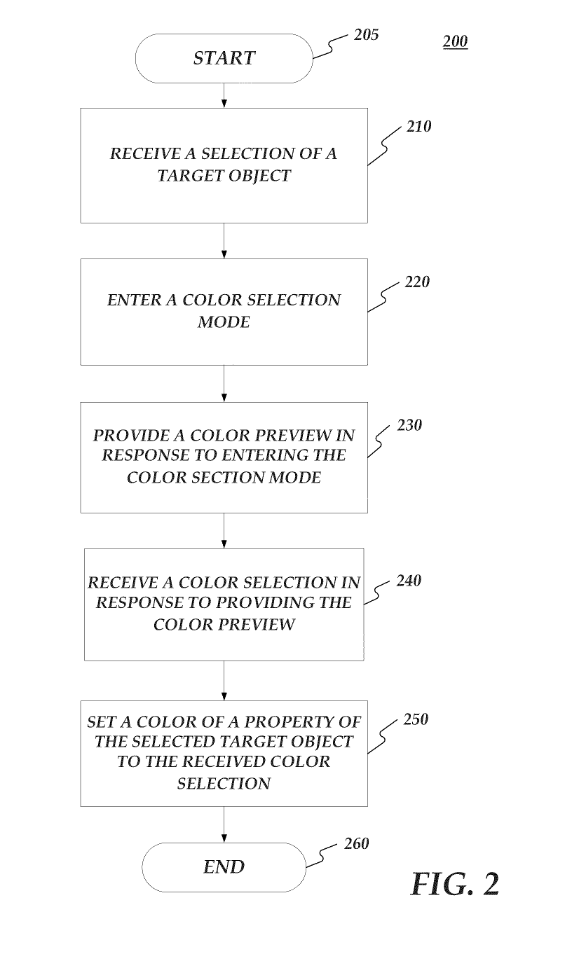

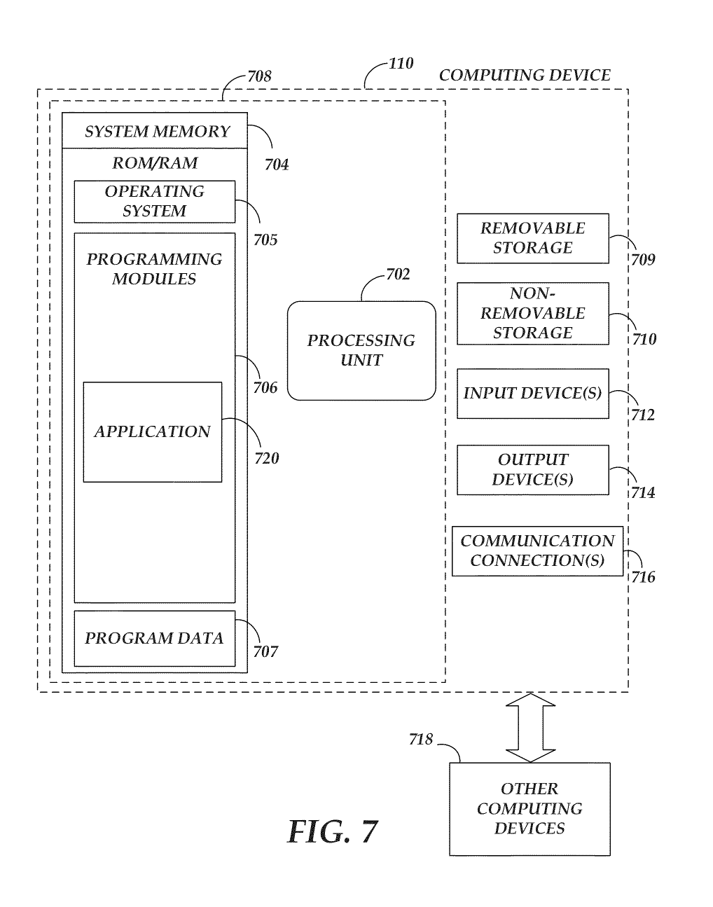

FIG. 2 is a flow chart setting forth the general stages involved in a method 200 consistent with an embodiment of the invention for providing color selection. Method 200 may be implemented using computing device 110 as described above with respect to FIG. 1 and in more detail below with respect to FIG. 7. Ways to implement the stages of method 200 will be described in greater detail below.

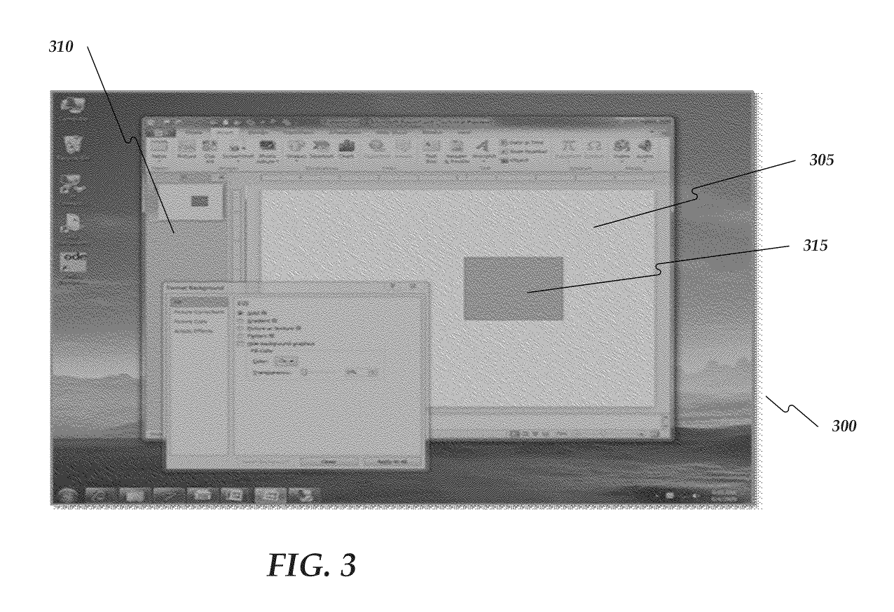

Method 200 may begin at starting block 205 and proceed to stage 210 where computing device 110 may receive a selection of a target object. For example, FIG. 3 is a diagram illustrating a computing device screen 300. As shown in FIG. 3, screen 300 may include a window displayed, for example, by a slide deck presentation application including a slide work space 305 and an area 310 that is outside of slide work space 305. Slide work space 305 may include an object 315 (e.g. the target object). Using a mouse, for example, the user may click on object 315 to select it. In response, computing device 110 may receive the selection of object 315.

From stage 210, where computing device 110 receives the selection of target object 315, method 200 may advance to stage 220 where computing device 110 may enter a color selection mode. For example, the color selection mode may be entered into in response to computing device 110 receiving the selection of object 315 and in response to computing device 110 receiving a user initiated input. The user initiated input may comprise the user selecting a button associated with, for example, the color selection mode of the slide deck presentation application.

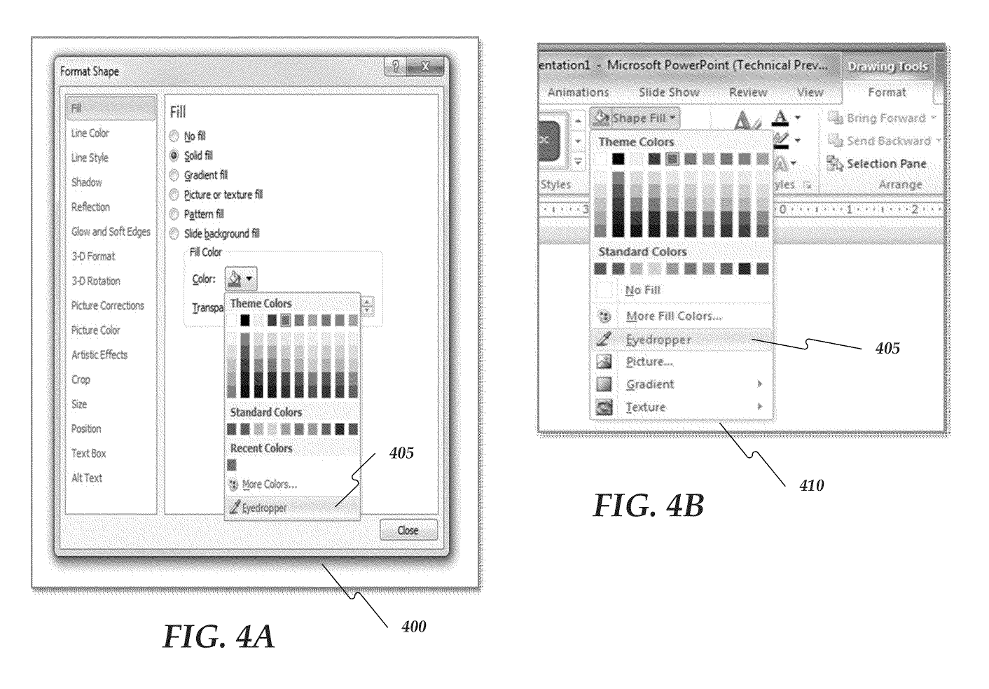

Interacting with the slide deck presentation application, the user may cause a format object dialog box 400 to appear that includes a color selection mode button 405 as shown in FIG. 4A or a drop down menu 410 to appear that includes color selection mode button 405 as shown in FIG. 4B. The user may select color selection mode button 405 to cause the slide deck presentation application running on computing device 110 to enter the color selection mode.

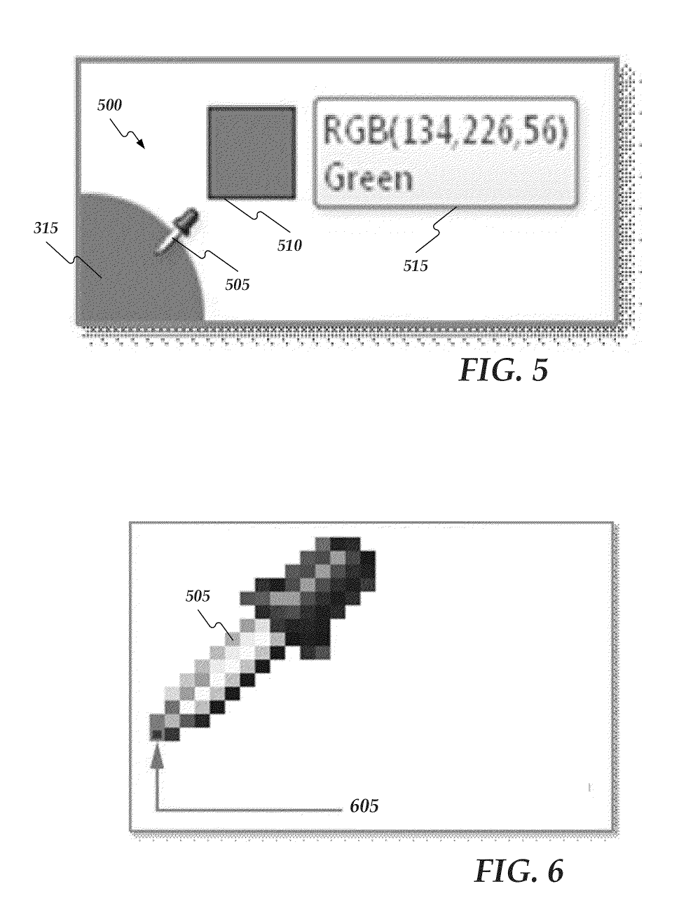

Once computing device 110 enters the color selection mode in stage 220, method 200 may continue to stage 230 where computing device 110 may provide a color preview in response to entering the color selection mode. For example, when the color selection mode is entered, a mouse pointer may be re-presented as a user manipulatable pointer 500 as shown in FIG. 5. User manipulatable pointer 500 may include an icon 505, a preview loupe 510, and a tooltip 515. FIG. 6 is a diagram illustrating icon 505. As shown in FIG. 6, icon 505 may include a bottom-left pixel 605 configured to indicate a current color as will be described in greater detail below. Preview loupe 510 may comprise an area filled with the current color and tooltip 515 comprises information corresponding to the current color.

Consistent with embodiments of the invention, as the user moves user manipulatable pointer 500 within slide work space 305, a live preview of the current color is displayed in user manipulatable pointer 500. Bottom-left pixel 605 may act as a “hotspot” and may determine the current color. In other words, the color of the pixel on the screen under bottom-left pixel 605 may be “raised” and previewed in user manipulatable pointer 500. Preview loupe 510 may act as a “magnifier” and may facilitate the user seeing the current color that is selected by bottom-left pixel 605. For example, preview loupe 510 may be filled with the RGB color of the currently selected screen pixel (i.e., under bottom-left pixel 605). As user manipulatable pointer 500 moves, the fill of preview loupe 510 may be update in real time.

Tooltip 515 may provide the user with information about the current color. The information provided by tooltip 515 may appear, for example, on hover after one second of no movement of user manipulatable pointer 500. The information provided by tooltip 515 may appear near user manipulatable pointer 500 and its position may be determined as appropriate by the operating system of computing device 110. The information provided by tooltip 515 may comprise the RGB value and the “friendly” color name of the current color. It may appear on two lines:

RGB (###,###,###)

Color Name

The information provided by tooltip 515 may disappear upon movement of user manipulatable pointer 500 or when the color selection mode is exited.

Consistent with embodiments of the invention, an active state may be maintained when user manipulatable pointer 500 is within slide work space 305. When the user causes user manipulatable pointer 500 to leave slide work space 305 (e.g. enter area 315) a passive state may be maintained. In the active state, the user may be able to click and sample a color. In the passive state, the user may be able to interact with application and operating system controls. In the passive state, user manipulatable pointer 500 may be replaced with a normal mouse pointer.

After computing device 110 provides the color preview in stage 230, method 200 may proceed to stage 240 where computing device 110 may receive a color selection in response to providing the color preview. For example, once a desired color has been found, the user may left-click the mouse to select the current color.

Once computing device 110 receives the color selection in stage 240, method 200 may continue to stage 250 where computing device 110 may set a color of a property of object 315 consistent with the received color selection. Once computing device 110 sets the color of the property of the selected target object in stage 250, method 200 may then end at stage 260.

FIG. 7 is a block diagram of a system including computing device 110. Consistent with an embodiment of the invention, the aforementioned memory storage and processing unit may be implemented in a computing device, such as computing device 110 of FIG. 7. Any suitable combination of hardware, software, or firmware may be used to implement the memory storage and processing unit. For example, the memory storage and processing unit may be implemented with computing device 110 or any of other computing devices 718, in combination with computing device 110. The aforementioned system, device, and processors are examples and other systems, devices, and processors may comprise the aforementioned memory storage and processing unit, consistent with embodiments of the invention.

With reference to FIG. 7, a system consistent with an embodiment of the invention may include a computing device, such as computing device 110. In a basic configuration, computing device 110 may include at least one processing unit 702 and a system memory 704. Depending on the configuration and type of computing device, system memory 704 may comprise, but is not limited to, volatile (e.g. random access memory (RAM)), non-volatile (e.g. read-only memory (ROM)), flash memory, or any combination. System memory 704 may include operating system 705, one or more programming modules 706, and may include a program data 707. Operating system 705, for example, may be suitable for controlling computing device 110's operation. In one embodiment, programming modules 706 may include, for example, application 720. Furthermore, embodiments of the invention may be practiced in conjunction with a graphics library, other operating systems, or any other application program and is not limited to any particular application or system. This basic configuration is illustrated in FIG. 7 by those components within a dashed line 708.

Computing device 110 may have additional features or functionality. For example, computing device 110 may also include additional data storage devices (removable and/or non-removable) such as, for example, magnetic disks, optical disks, or tape. Such additional storage is illustrated in FIG. 7 by a removable storage 709 and a non-removable storage 710. Computing device 110 may also contain a communication connection 716 that may allow computing device 110 to communicate with other computing devices 718, such as over a network in a distributed computing environment, for example, an intranet or the Internet. Communication connection 716 is one example of communication media.

The term computer readable media as used herein may include computer storage media. Computer storage media may include volatile and nonvolatile, removable and non-removable media implemented in any method or technology for storage of information, such as computer readable instructions, data structures, program modules, or other data. System memory 704, removable storage 709, and non-removable storage 710 are all computer storage media examples (i.e., memory storage). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 110. Any such computer storage media may be part of device 700. Computing device 110 may also have input device(s) 712 such as a keyboard, a mouse, a pen, a sound input device, a touch input device, etc. Output device(s) 714 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

As stated above, a number of program modules and data files may be stored in system memory 704, including operating system 705. While executing on processing unit 702, programming modules 706 (e.g. application 720) may perform processes including, for example, one or more method 200's stages as described above. The aforementioned process is an example, and processing unit 702 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Embodiments of the invention may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the invention, may be performed via application-specific logic integrated with other components of computing device 110 on the single integrated circuit (chip). Moreover, the components illustrated in FIG. 7 may be practiced, for example, in a mobile device or in a cloud computing system.

Computing device 110 may be coupled to a camera that may be operative to record user 105 and capture motions and/or gestures made by user 105. Computing device 110 may be further operative to capture words spoken by user 105, such as by a microphone, and/or capture other inputs from user 105 such as by a keyboard and/or mouse. Consistent with embodiments of the invention, the camera may comprise any motion detection device capable of detecting the movement of user 105. For example, the camera may comprise a Microsoft® Kinect® motion capture device comprising a plurality of cameras and a plurality of microphones.

Moreover, customizing the visual appearance of a chart may be difficult for users. Conventional systems force users to customize every piece of the chart at once, with no flexibility to easily mix and match custom formatting on individual pieces of the chart. Consistent with embodiments of the invention, a model may be provided that allows user to mix and match the color scheme and style options available for charts. This may allow users to either choose one of preset color schemes available or use their own in conjunction with the preset styles. The style options may also add, remove, and/or reposition elements on the chart to fit the style. Moreover, embodiments of the invention may provide a new flexible style model that reacts to the current selection and provides styles that are tailored for that chart element.

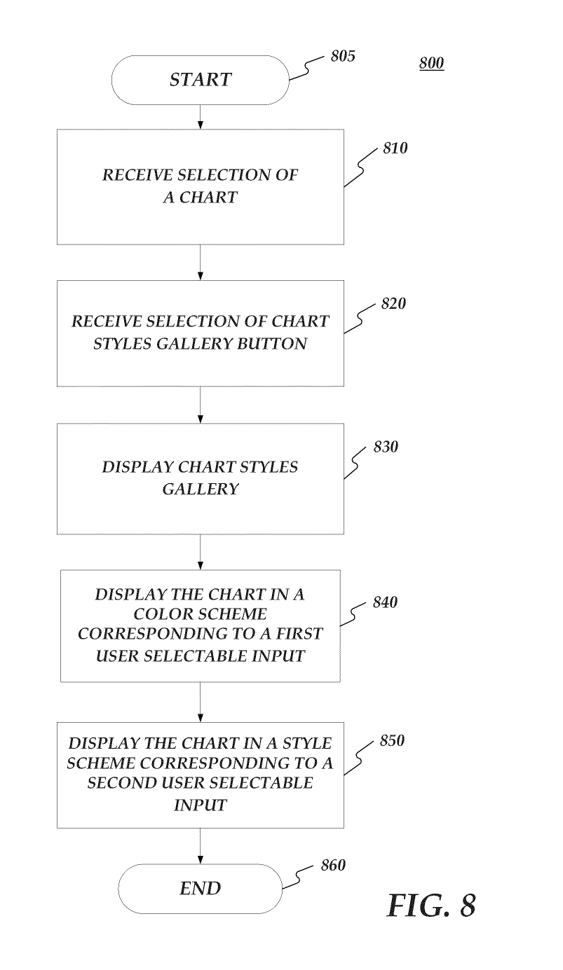

FIG. 8 is a flow chart setting forth the general stages involved in a method 800 consistent with an embodiment of the invention for providing chart styles. Method 800 may be implemented using computing device 110 as described in more detail above with respect to FIG. 7. Ways to implement the stages of method 800 will be described in greater detail below.

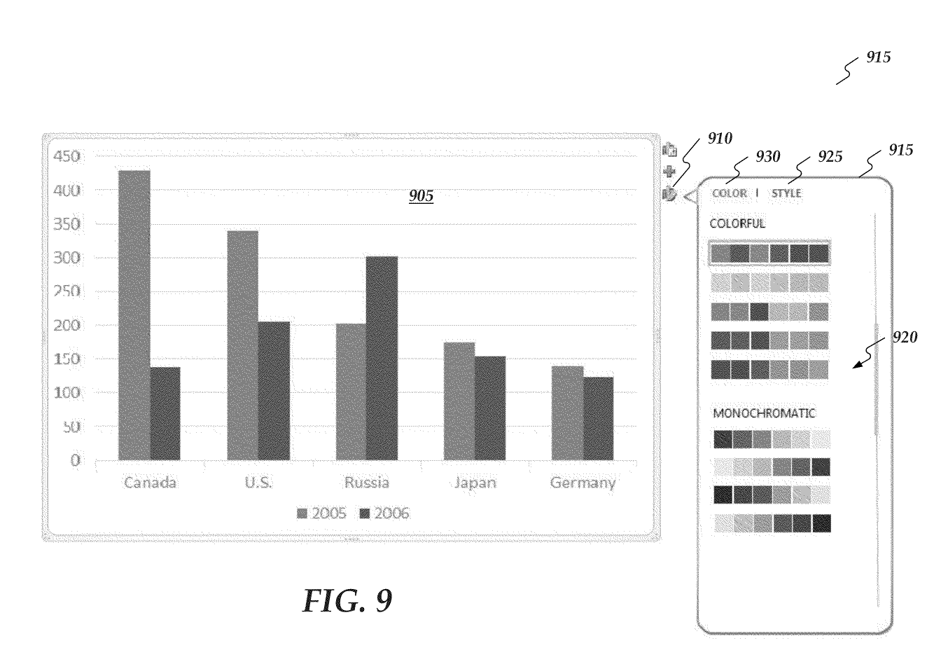

Method 800 may begin at starting block 805 and proceed to stage 810 where computing device 110 may receive a selection of a chart 905 as shown in FIG. 9. For example, interacting with computing device 110, user 105 may select chart 905. User 105 may click a mouse on chart 905 displayed on a display device corresponding to computing device 110.

From stage 810, where computing device 110 receives the selection of chart 905, method 800 may advance to stage 820 where computing device 110 may receive a selection of a chart styles gallery button. For example, user 105 may hover over a launch button 910 (e.g. the chart styles gallery button) causing a chart styles tooltip to appear. User 105 may then click on launch button 910 to open a chart styles gallery 915.

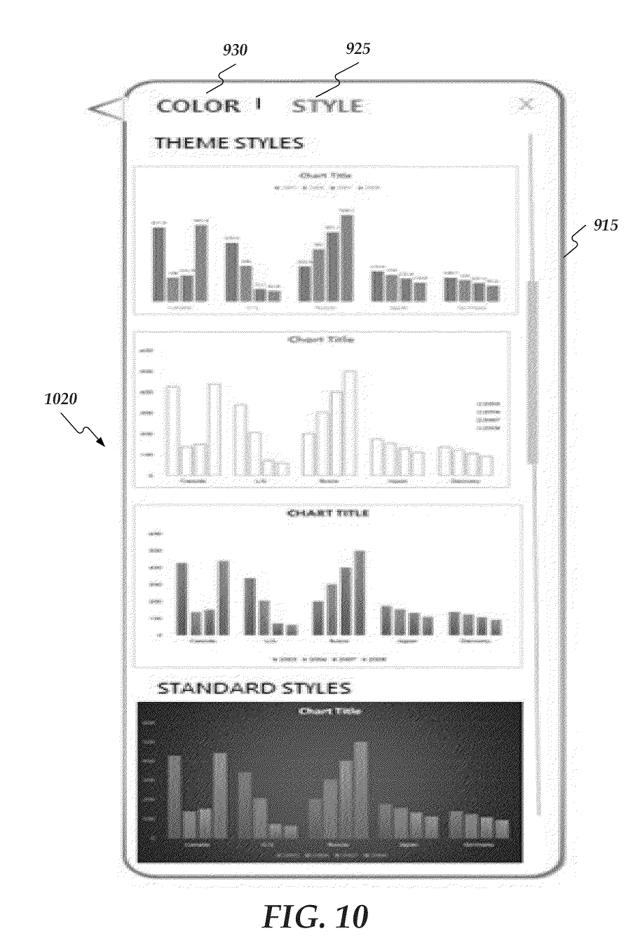

Once computing device 110 receives the selection of the chart styles gallery button in stage 820, method 800 may continue to stage 830 where computing device 110 may display chart styles gallery 915. For example, in response to user 105 clicking launch button 910, chart styles gallery 915 may appear. Consistent with embodiments of the invention, two types of galleries may be available: a color gallery 920 (as illustrated in FIG. 9) or a style gallery 1020 (as illustrated in FIG. 10). By default, color gallery 920 may be shown initially on display of chart styles gallery 915, but style gallery 1020 could be shown initially. If user 105 changes a document theme, a color scheme, or an effect scheme, for example, the galleries (e.g. color gallery 920 or a style gallery 1020) may be refreshed.

Color gallery 920 may allow user 105 to change the color scheme for all data series in chart 905. As shown in FIG. 9, color options may be displayed using, but not limited to, rectangles displaying the color scheme. The rectangle may show the color that would be generated for six series, for example, since the colors change slightly as more than six series are added to chart 905. Consistent with embodiments of the invention, if user 105 already has a style set from chart styles gallery 915, color gallery 920 may only update the solid fill color and may not remove a fill effect such as a gradient that was applied via chart styles gallery 915. Moreover, embodiments of the invention may specify fill, line, and effect reference colors and then fill, line and effect formatting with optionally empty slots for those colors to go. The fill, line and effect reference colors may be document color or colors from the color style (see below). This may allow for the chart style to specify a gradient fill with one stop being a solid black and another stop pulling from the color style. This may be more flexible than just a single color not overriding a gradient fill.

Consistent with embodiments of the invention, the color scheme may have any set of colors, document theme or hardcoded like RGB/CMYK and may have a list of color transform variations to extend the scheme to more colors. For example, a color scheme of Red, Green, Blue can be specified and then a variation list of No Change, Dark, Lighter and the user may get a set of nine colors Red, Green, Blue, Dark Red, Dark Green, Dark Blue, Light Red, Light Green, Light Blue. In other words, the color scheme on a chart may be linked to the documents theme so the color scheme can specify, for example, Accent1 or Background1 instead of a color like Red. In addition, color styles may also specify interpolation and extrapolation algorithms. For example, if the color style is 3 colors, Red, Green, Blue, but the chart needs 4 colors, embodiments of the invention may cycle back to red, linear interpolate or pick from the middle, and expand outwards for example. This may stack on top of color variations above.

After computing device 110 displays chart styles gallery 915 in stage 830, method 800 may proceed to stage 840 where computing device 110 may display chart 905 in a color scheme corresponding to a first user selectable input. For example, user 105 may see chart styles gallery 915 floating to the right of chart 905. With the mouse cursor, user 105 may hover over the color schemes in color gallery 920 to see a live preview in chart 905 of the hovered color scheme. Once user 105 has found a desired color scheme, user 105 may click on the desired color scheme (e.g. produce the first user selectable input) to apply the desired color scheme, and thus causing chart 905 to be displayed with the desired color scheme.

Consistent with embodiments of the invention, the type of chart displayed in chart 905 may have implications for the color scheme. For example, for non-pie charts, when user 105 selects these color variations, they may apply to the series level. For pie charts, they may apply to data points (unless user 105 has turned off vary color by slice). For other chart types where there is only a single series, the gallery may operate the same as it does for multi-series unless the user has set selected to “Vary Colors by Point”. Consistent with embodiments of the invention, chart style may affect how the color style is applied to each element. Series can follow the color style based on their index in the chart or be mapped to an explicit index specified by the style. Non series objects can also be mapped to an explicit index by the style. This may allow chart elements like the background to follow the color style. It also may allows series to be formatted in a constant color but have their annotations be the differentiating factor (like data labels or error bars being the objects that follow the color style.)

From stage 810, where computing device 110 displays chart 905 in the color scheme corresponding to the first user selectable input, method 800 may advance to stage 820 where computing device 110 may display chart 905 in a style scheme corresponding to a second user selectable input. For example, user 105 may click a styles button 925 in chart styles gallery 915 to cause the available styles to be displayed (e.g. cause style gallery 1020 to be displayed) as shown in FIG. 10. User 105 may then hover over the style options available in style gallery 1020 to get a preview and then select the best liked style.

Consistent with embodiments of the invention, style gallery 1020 may allow user 105 to change the overall style of chart 905. There may be two categories of styles available in style gallery 1020, theme styles and standard styles. Theme Styles may be mapped to theme fill/effect slots. Standard styles may comprise additional styles that have specified fill, effect, and other properties set. However, consistent with embodiments of the invention, style not have to be entirely theme or standard, each part of the chart can be all theme, partly theme and partly standard or all standard. They may map to theme fill, line and effects. Additionally text elements can map to theme fonts or an explicit font. Text may map its fill, line, and effects independently of non-text for each chart element.

Different option may be displayed in style gallery 1020 using, for example, the bitmap framework to display user 105's current chart 905 with the style applied to it. Since data series colors may not be set in a style, the bitmaps may need to pick up the color scheme selected for user 105's chart 905, apply any overrides to the color scheme, and then apply the styles to these in order to generate the bitmaps. If, for example, user 105 has manually set an override on the color scheme by setting the solid fill directly, then this may not be removed when applying a style. If chart 905 does not currently have a solid fill set, then the style may do the following in precedence order: use the last color scheme user 105 applied through chart styles gallery 915, if no color scheme has been applied directly, then use the default color scheme. Depending on the chart type selected, user 105 may see a different set of style options available. User 105 may toggle between color gallery 920 and style gallery 1020 by selecting a color button 930 and styles button 925. Once computing device 110 displays the chart in the style scheme corresponding to the second user selectable input in stage 840, method 800 may then end at stage 850.

Consistent with embodiments of the invention, color and style may be broken down and applied to individual elements of chart 905. For example, the legend, the title, and the bars of chart 905 may each have their own set of styles that user 105 could choose from and then mix and match all together. In other words, user 105 may select different pieces of chart 905 and apply, for example, colors and styles that are specific to those pieces. Furthermore, the style may also specify element styles for types that are not on the chart. For example, adding a legend after choosing a Chart Style may apply that style's legend style to the chart at that time.

An embodiment consistent with the invention may comprise a system for providing color selection. The system may comprise a memory storage and a processing unit coupled to the memory storage. The processing unit may be operative to receive a selection of a target object and enter a color selection mode. In addition, the processing unit may be operative to provide a color preview in response to entering the color selection mode, receive a color selection in response to providing the color preview, and set a color of a property of the selected target object to the received color selection.

Another embodiment consistent with the invention may comprise a system for providing color selection. The system may comprise a memory storage and a processing unit coupled to the memory storage. The processing unit may be operative to receive selection of a chart, receive selection of chart styles gallery button, and display chart styles gallery. In addition, the processing unit may be operative to display the chart in a color scheme corresponding to a first user selectable input and display the chart in a style scheme corresponding to a second user selectable input.

Yet another embodiment consistent with the invention may comprise a system for providing chart styles. The system may comprise a memory storage and a processing unit coupled to the memory storage. The processing unit may be operative to entering a color selection mode in response to receiving a selection of a target object and a user initiated input. In addition, the processing unit may be operative to provide a color preview in response to entering the color selection mode. The color preview may be maintained in an active state while a user manipulatable pointer is within a slide work space containing the target object. The user manipulatable pointer may comprise a color selection icon, a preview loupe, and a tooltip. The icon may comprise a bottom-left pixel configured to indicate a current color. The preview loupe may comprise an area filled with the current color. And the tooltip may comprise information corresponding to the current color. Moreover, the processing unit may be operative to receive, in response to providing the color preview, a color selection corresponding to the current color and to set a color of a property of the selected target object to the received color selection.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing color selection, the method comprising:
receiving a selection of a target object;
entering a color selection mode;
providing a color preview in response to entering the color selection mode;
receiving a color selection in response to providing the color preview; and
setting a color of a property of the selected target object to the received color selection.

2. The method of claim 1, wherein receiving the selection of the target object comprises receiving the selection of the target object in response to a first user initiated input.

3. The method of claim 1, wherein receiving the selection of the target object comprises receiving the selection of the target object wherein the target object is within a slide work space.

4. The method of claim 1, wherein entering the color selection mode comprises entering the color selection mode in response to a second user initiated input.

5. The method of claim 1, wherein entering the color selection mode comprises entering the color selection mode in response to receiving the selection of the target object and a second user initiated input.

6. The method of claim 1, wherein providing the color preview comprises providing the color preview when in an active state.

7. The method of claim 1, wherein providing the color preview comprises providing the color preview when in an active state being maintained while a user manipulatable pointer is within a slide work space containing the target object.

8. The method of claim 1, wherein providing the color preview comprises displaying a user manipulatable pointer comprising a color selection icon, a preview loupe, and a tooltip.

9. The method of claim 8, wherein displaying the user manipulatable pointer comprises displaying the user manipulatable pointer wherein the icon comprises a bottom-left pixel configured to indicate a current color.

10. The method of claim 8, wherein displaying the user manipulatable pointer comprises displaying the user manipulatable pointer wherein the preview loupe comprises an area filled with a current color.

11. The method of claim 8, wherein displaying the user manipulatable pointer comprises displaying the user manipulatable pointer wherein the tooltip comprises information corresponding to a current color.

12. The method of claim 1, further comprising ceasing the color selection mode in response to entering a passive state.

13. The method of claim 12, wherein entering the passive state comprises detecting that a user manipulatable pointer is outside a slide work space containing the target object.

14. A system for providing chart styles, the system comprising:
a memory storage; and
a processing unit coupled to the memory storage, wherein the processing unit is operative to:
receive selection of a chart;
receive selection of chart styles gallery button;
display chart styles gallery;
display the chart in a color scheme corresponding to a first user selectable input; and
display the chart in a style scheme corresponding to a second user selectable input.

15. The system of claim 14, wherein the processing unit being operative to display the chart in the color scheme corresponding to the first user selectable input comprises the processing unit being operative to display the chart in the color scheme corresponding to the first user selectable input being selected from a color gallery displayed in the chart styles gallery.

16. The system of claim 15, wherein the color gallery comprises a plurality of rectangles each respectively corresponding to an available color scheme, the first user selectable input being selected from one of the plurality of rectangles.

17. The system of claim 14, wherein the processing unit being operative to display the chart in the style scheme corresponding to the second user selectable input comprises the processing unit being operative to display the chart in the style scheme corresponding to the second user selectable input being selected from a style gallery displayed in the chart styles gallery.

18. The system of claim 17, wherein the style gallery comprises a plurality of chart previews each respectively corresponding to an available style scheme, the second user selectable input being selected from one of the plurality of chart previews.

19. The system of claim 17, wherein at least one of the color scheme and the style scheme is applied to individual elements of the chart.

20. A computer-readable medium that stores a set of instructions which when executed perform a method for providing color selection, the method executed by the set of instructions comprising:
entering a color selection mode in response to receiving a selection of a target object and a user initiated input;
providing a color preview in response to entering the color selection mode, wherein providing the color preview comprises providing the color preview when in an active state being maintained while a user manipulatable pointer is within a slide work space containing the target object, the user manipulatable pointer comprising a color selection icon, a preview loupe, and a tooltip, wherein the icon comprises a bottom-left pixel configured to indicate a current color, the preview loupe comprises an area filled with the current color, and the tooltip comprises information corresponding to the current color;
receiving, in response to providing the color preview, a color selection corresponding to the current color; and
setting a color of a property of the selected target object to the received color selection.
